(19) United States
(12) Patent Application Publication
(10) Pub. No.: US 2007/0271231 A1
(43) Pub. Date: Nov. 22, 2007

(54) Search method on the Internet

(76) Inventor: Jimmy Jong-Yuan Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/437,789

(22) Filed: May 22, 2006

(51) Int. Cl. G06F 17/30

(52) U.S. Cl. 707/3

(57) ABSTRACT

This invention is a search method that can be applied on the Internet. Based on the various combinations of the keyword language, which may or may not be the same as that used on one or more search engines, the results vary. If the language of the first keyword is different from that of the web site, the keyword is translated into the second keyword. The first keyword and the second keyword are searched on the first and the second web sites respectively, and thus generate the first and the second search results, which are in the form of web pages. It the languages of the result web pages are different from that a user desires, the first and the second result web pages would be translated into the third and the fourth web pages before delivering them to the user. This method makes Internet searches easier and reduces language barriers.

### BACKGROUND OF THE INVENTION

1. Field of Invention

The present invention relates in general to a search method, and more particularly, to the search method for translating search keywords and search result web pages according to user's demands to make Internet search easier on the Internet.

2. Description of Related Art

The rapidly developing Internet makes people get information from distance easily. In addition, a variety of information is showed on private or government web sites in local languages, such as traveling information, national economic status and academic papers. Due to the URLs of those web sites are not well known to the public, search engines then provide a way to help people find information they need. The following is a detailed description on how to do searches in the Internet.

Refer to the FIG. 1, it is the flow chart of the well-known Internet search process. As shown in the Figure, a user enters a keyword in the text area of a web page provided by a search engine in step S10. Then, follow the step S20, the search engine finds the keyword in its database. In the step S30, the search engine generates search results, which is in the form of a series of web pages, and responds them to the user.

Although the searching algorithm used in the search engine has made a lot of progresses, the search results are not shown in the user's desired language by the search engine. In addition, people may want the search results come from multiple language databases in a single search. However, the well-known search method can only support keywords in one language. If a user wants to do searches in multiple languages, the language barrier makes him/her difficult to accomplish the task. The search result pages come from multiple languages database, again, make them difficult to be utilized. The unfamiliarity of the language would prevent people, who are not familiar with foreign languages, from viewing foreign web sites.

Therefore, how to propose a new search method to overcome the barrier of multiple language searches and translate the search result pages to user desired language in real-time is the objective of this invention. The inventor has been working on researching, developing, and sale of the Internet related products for years. He now comes up with the new search method that can solve the problems described above.

### SUMMARY OF THE INVENTION

The primary objective of the present invention is to provide a new Internet search method that translates the first search keyword into the second search keyword. The first and the second keywords are used to do searches in the first and the second search engines respectively.

The secondary objective of the present invention is to provide an Internet search method that translates search keywords according to network allocations. The translated keywords are then used in the subsequent searches in different search engines according to network allocations.

Another objective of the present invention is to provide an Internet search method that uses the same keyword and does searches in more than one search engines at the same time.

Yet another objective of the present invention is to provide an Internet search method that translates the search keyword according to the languages of search engines. The same keyword thus can be used in multiple search engines, whether same or different languages, at the same time.

Yet another objective of the present invention is to provide an Internet search method that translates the search result pages to user desired language.

The present invention provides an Internet search method that can be used in multiple language searches at the same time. The first search keyword is translated into the second search keyword. The first and the second keywords are then used to do searches in multiple search engines or, the original keyword is used to do searches in the first and the second search engines simultaneously or, the original keyword is translated according to network allocation and then do searches or, a keyword is used to do searches in the first language or the second language search engine. In addition, the search result web pages are translated into multiple languages. The present invention makes keyword searching and search result viewing easier.

### BRIEF DESCRIPTION OF ACCOMPANIED DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 shows a Flow-chart of the well-known search method on the Internet;

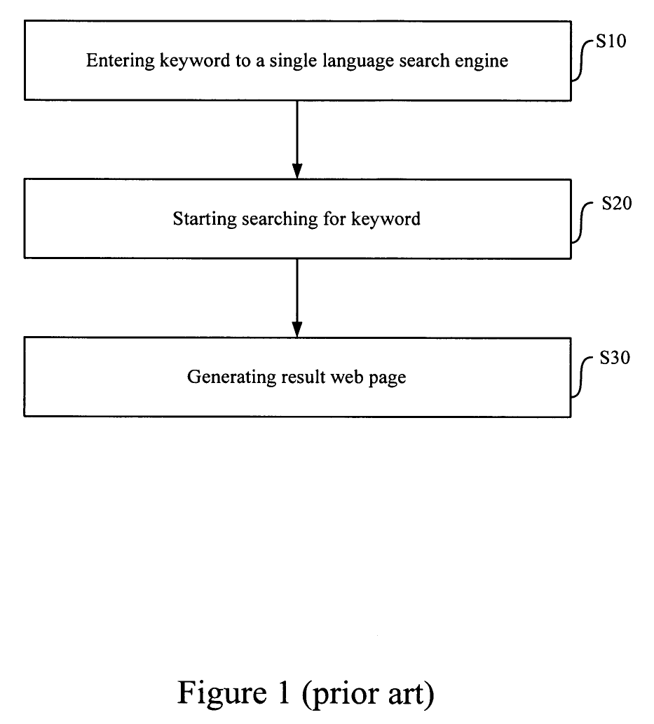

FIG. 2 shows a Block diagram according to embodiment of the present invention;

FIG. 3 shows a Flow-chart according to one embodiment of the present invention;

FIG. 4 shows a Block diagram according to one embodiment of the FIG. 3;

FIG. 5 shows a Flow-chart according to another one embodiment of the present invention;

FIG. 6 shows a Block diagram according to one embodiment of the FIG. 5;

FIG. 7 shows a Flow-chart according to another one embodiment of the present invention;

FIG. 8 shows a Block diagram according to one embodiment of the FIG. 7;

FIG. 9 shows a Flow-chart according to another one embodiment of the present invention;

FIG. 10 shows a Block diagram according to one embodiment of the FIG. 9;

FIG. 11 shows a Flow-chart according to another one embodiment of the present invention;

FIG. 12 shows a Block diagram according to one embodiment of the FIG. 11;

FIG. 13 shows a Flow-chart according to another one embodiment of the present invention;

FIG. 14 shows a Block diagram according to one embodiment of the FIG. 13;

FIG. 15 shows a Flow-chart according to another one embodiment of the present invention;and

FIG. 16 shows a Block diagram according to one embodiment of the FIG. 15.

### DESCRIPTION OF THE PREFERRED EMBODIMENT

The examples and descriptions regarding this invention are described as following:

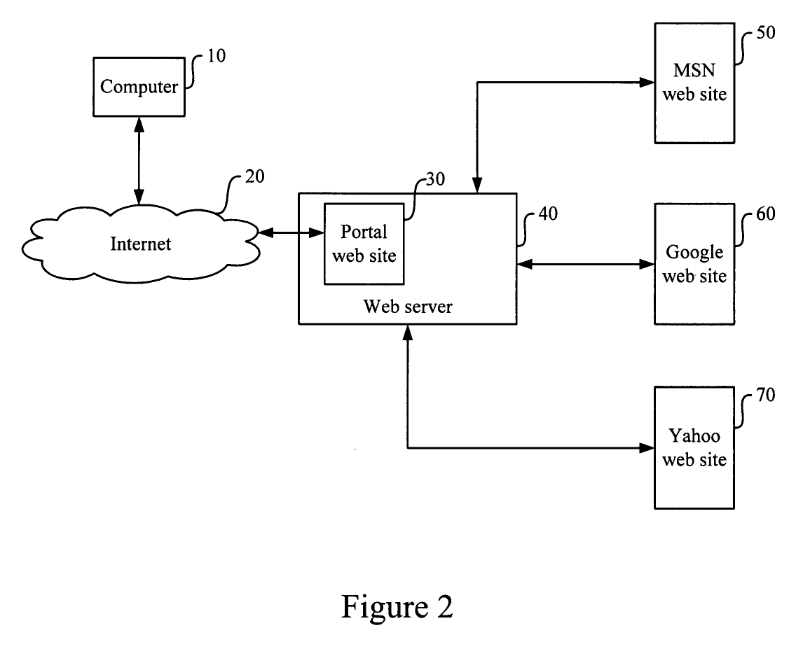

Firstly, refer to FIG. 2. It is the flow-chart of this invention, which can be applied on the Internet. As shown in the Figure, a user using a web browser of a computer 10 connects to a portal web site 30 on the Internet 20. The portal web site 30 is usually deployed on a web server 40. The user starts a search by entering a keyword in the portal web site 30. The keyword is processed by the web server 40 and sent to MSN site 50, Google site 60 and Yahoo site 70 to carry out the search and generate result web pages. The web server 40 sends out the keyword, which may or may not be translated in advance. More examples and detailed descriptions follows.

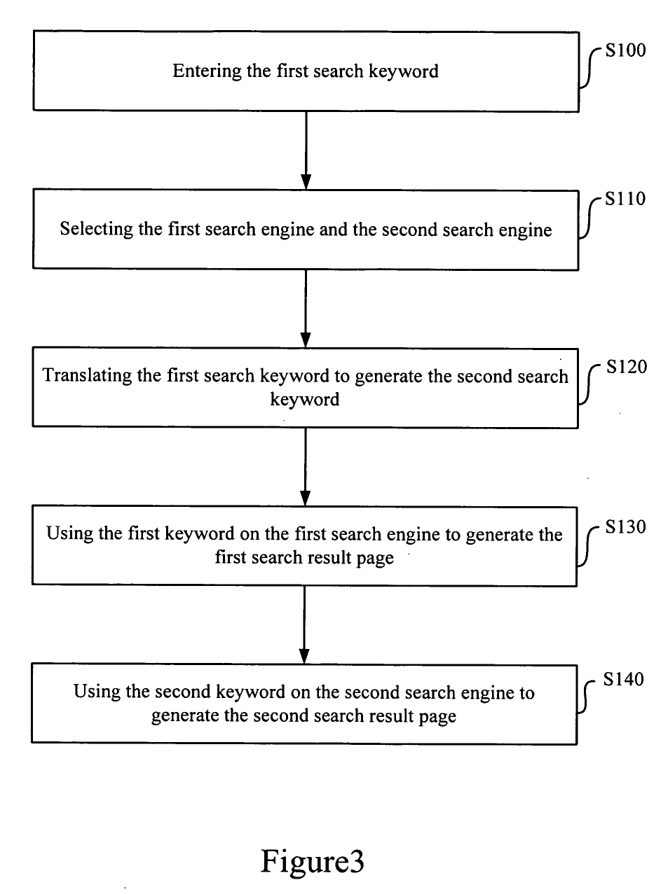

Refer to FIG. 3, which is a block diagram of a better example. As shown in the Figure, this invention is a search method that translates input keyword to the languages used in multiple search engines. In step S100, user enters the first search keyword into the text area of a web page provided by a search engine. A single or multiple words compose the first search keyword. In step S110, the user selects the first search engine and the second search engine. When the searches start, in step S120, web server translates the first search keyword into the second search keyword.

Then, in step S130, the web server applies the first or the second search keyword on the first search engine. The first search engine generates the first search result page according to the first or the second search keyword. The language used in the first search result page is the same as that used in the first search engine. In step S140, the web server applies the first or the second search keyword on the second search engine. The second search engine generates the second search result page according to the first or the second search keyword. The language used in the second search result page is the same as that used in the second search engine. Due to the fact that the first and the second search engine may contain multiple language databases, the language used in the first search engine is the same as that of the first or the second keyword and, the language used in the second search engine is the same as that of the first or the second keyword.

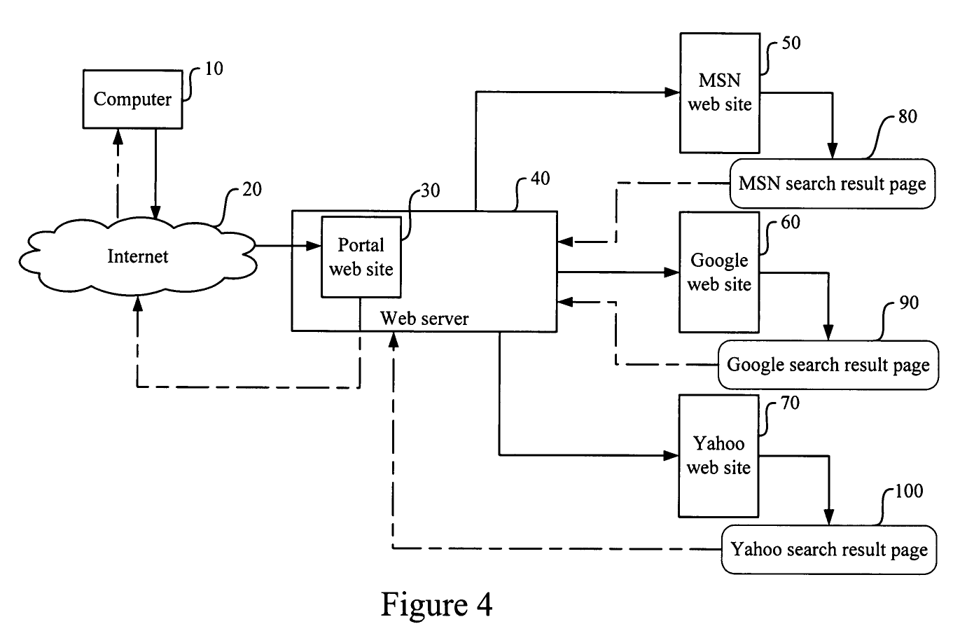

Refer to FIG. 4, which is the flow-chart of the Internet search method described in FIG. 3. As shown in the Figure, a user using a web browser of a computer 10 enters a Chinese search keyword to a portal web site 30. The web server 40 translates the keyword into English. Now the search can be done in either Chinese or English. The solid lines shown in the Figure are paths that the keyword is sent; center lines are paths that the result pages flow. A Taiwanese user uses a computer 10 to connect a portal site 30 via the Internet 20. The portal site 30 is deployed on a web server 40, which connects to multiple search engines, including MSN site 50, Google site 60 and Yahoo site 70. These search engines use both Chinese and English in their web sites as well as in databases.

A Taiwanese user uses a computer 10 and enters a keyword in Chinese into the portal site 30. Then, he selects multiple search engines and clicks a button, which enable the search. When the search starts, the web server 40 translates the Chinese keyword into English, and sends the Chinese keyword and the English keyword to multiple search engines. These search engines search their databases according to the Chinese keyword or the English keyword and generates search result pages, including MSN result page 80, Google result page 90 and Yahoo result page 100. The Taiwanese user thus gets multiple result web pages from portal site 30 and sees them shown on the computer 10.

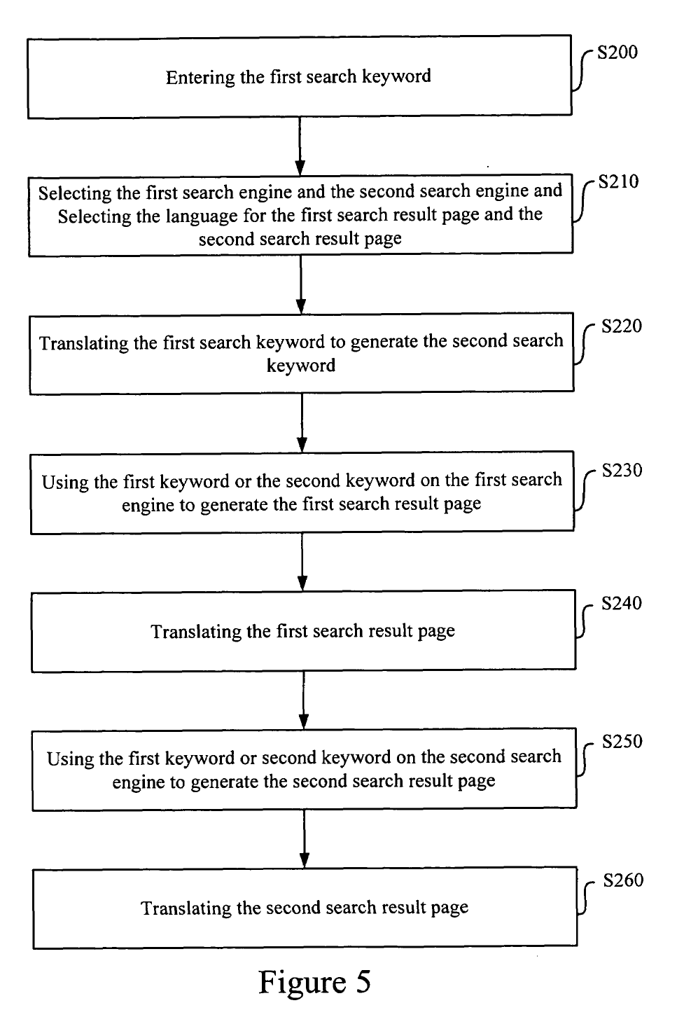

Refer to FIG. 5, which is a block diagram of a better example. The differences between FIG. 3 and FIG. 5 are that the first search result page uses the language same as that of the first search engine, the second search result page uses the language same as that of the second search engine in FIG. 3. However, the first search result page uses the language different from that of the first search engine, the second search result page uses the language different from that of the second search engine in FIG. 5. This invention includes the step that translates the first and the second search result pages. In step S210, a user selects the first and the second search engines and then select the language for the first and the second search result pages. In step S220, when the search starts, the web server translates the first search keyword to the second search keyword. In step S230, the web server uses the first or the second search keyword on the search engine and generates the first search result page.

In step S240, the web server translates the first search result page to a language, which is different from that used in the first search engine. In step S250, the web server uses the first or the second keyword on the second search engine and generates the second search result page. In step S260, the web server translates the second search result page to a language, which is different from that used in the second search engine. In this manner, other language users can view the first and the second search result pages.

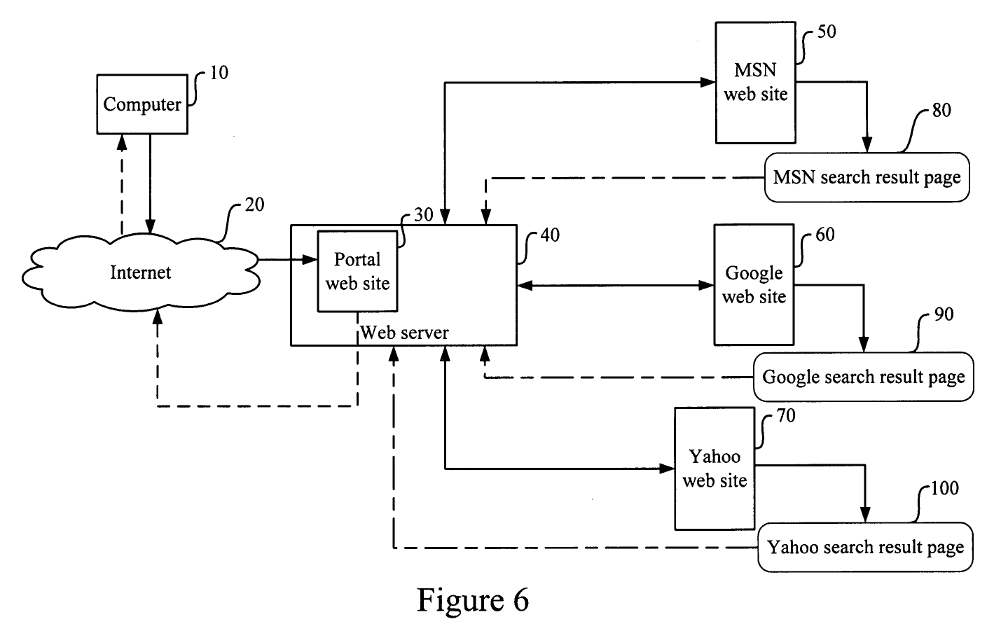

Refer to FIG. 6, which is the flow-chart of the Internet search method described in FIG. 5. As shown in the Figure, a user using a web browser of a computer 10 enters a Chinese search keyword to a portal web site 30. The web server 40 translates the keyword into English. Now the search can be done in either Chinese or English. The solid lines shown in the Figure are paths that the keyword is sent; center lines are paths that the un-translated result pages flow; dashed lines are paths that translated result pages flow. A Japanese user who is not familiar with Chinese asks a Taiwanese user uses a computer 10 to connect a portal site 30 via the Internet 20. The portal site 30 is deployed on a web server 40, which connects to multiple search engines, including MSN site 50, Google site 60 and Yahoo site 70.

The Taiwanese user uses a computer 10 and enters a keyword in Chinese into the portal site 30. Then, he selects multiple search engines, chooses the result pages to be shown in Japanese and click a button, which enable the search. When the search starts, the web server 40 translates the Chinese keyword into English, and sends the Chinese keyword and the English keyword to multiple search engines. These search engines search their databases according to the Chinese keyword or the English keyword and generates search result pages, including MSN result page 80, Google result page 90 and Yahoo result page 100. The search result pages are translated into Japanese by the web server 40 and can be viewed by the Japanese user.

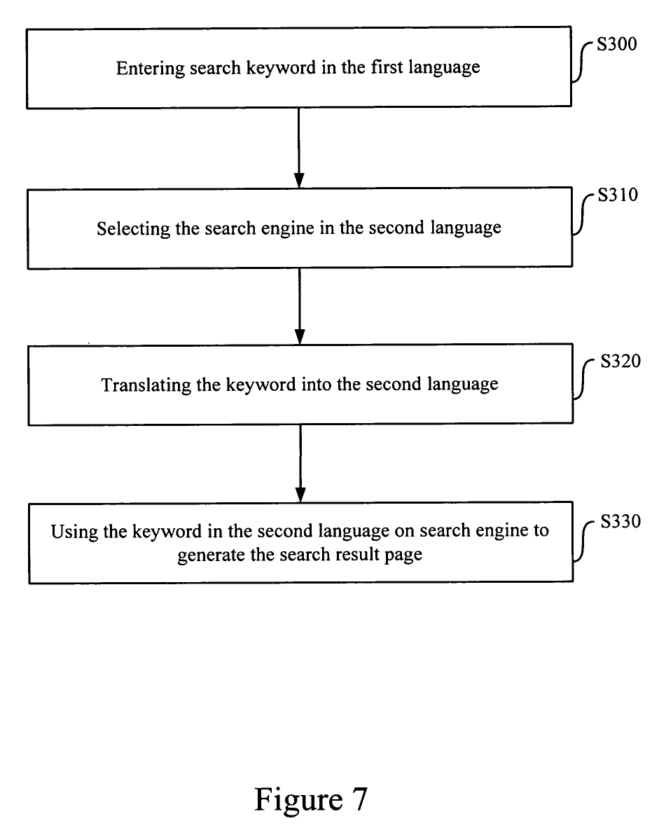

Refer to FIG. 7, which is a block diagram of a better example. The differences between FIG. 3 and FIG. 7 are that the first search keyword or the second search keyword uses the language same as that of the first search engine or the second search engine in FIG. 3. However, the keyword uses the language different from that of network allocation in FIG. 7. This invention includes the step S300, a user enters a search keyword, which is in the first language, into the text area of a portal web site.

In the step S310, user selects a network allocation, which uses the second language. A network allocation could be a network device, software, a firmware, or a search engine. In step S320, when the search starts, the web server translates the first search keyword to the language used in the network allocation. In step S330, the network allocation searches the translated keyword and generates the search result page, which is in the same language as that of network allocation.

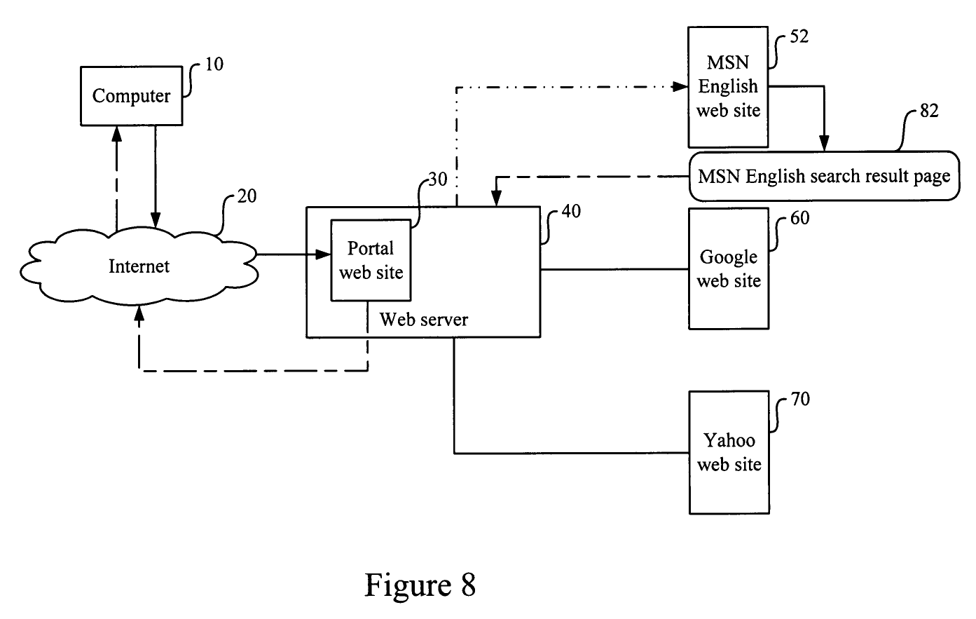

Refer to the FIG. 8, which is the flow-chart of the Internet search method described in FIG. 7. As shown in the Figure, a Taiwanese user using a web browser of a computer 10 enters a Chinese search keyword to a portal web site 30 and wants to do a search in English. The web server 40 translates the keyword into English. The solid lines shown in the Figure are paths that the un-translated keyword is sent; center lines are paths that the un-translated result pages flow; dashed lines are paths that translated result pages flow. A Taiwanese user uses a computer 10 to connect a portal site 30 via the Internet 20. The portal site 30 is deployed on a web server 40 which connects to multiple search engines, including MSN English site 52, Google site 60 and Yahoo site 70.

The Taiwanese user enters a keyword in Chinese into the portal site 30 from computer 10. He then selects MSN English web site 52 and click a button, which enables the search. When the search starts, the web server 40 translates the Chinese keyword into English, and sends the English keyword to MSN English web site 52. The result generated is MSN English result page 82. The Taiwanese user thus gets English result page from MSN English web site 52 and sees it shown on the computer 10.

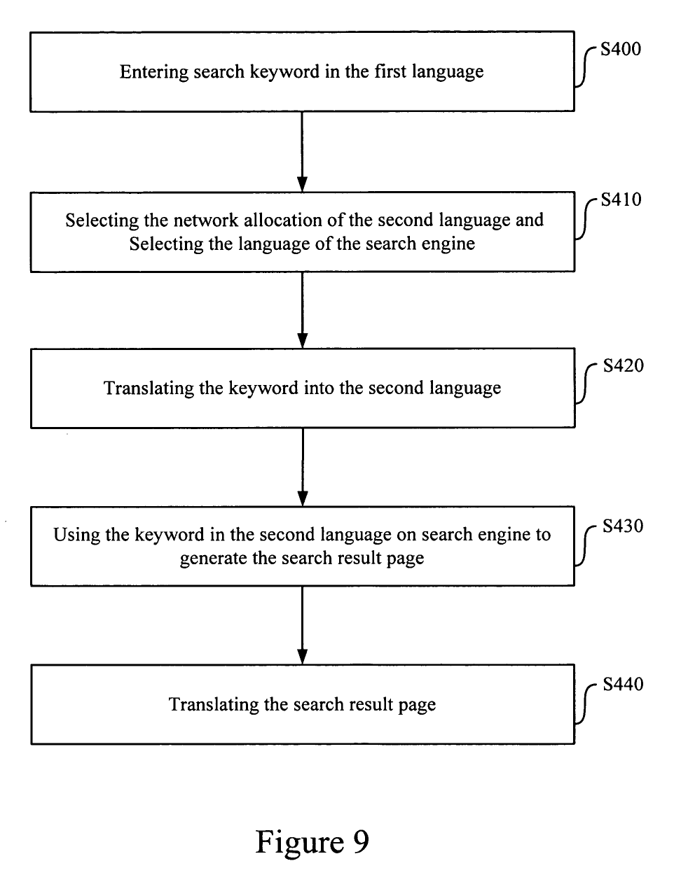

Refer to FIG. 9, which is a block diagram of a better example. The differences between FIG. 7 and FIG. 9 are that the language in the search result page is same as that of the search engine in FIG. 7. However, the language in the search result page is different from that of network allocation in FIG. 9. This invention includes the process that translates the search result page. In step S440, the web server translates the search result page to other language, which make it possible be viewed by different language users. The search result page can be translated to the first language that is the same as the search keyword, or to the third language that is different from both the keyword and the network allocation.

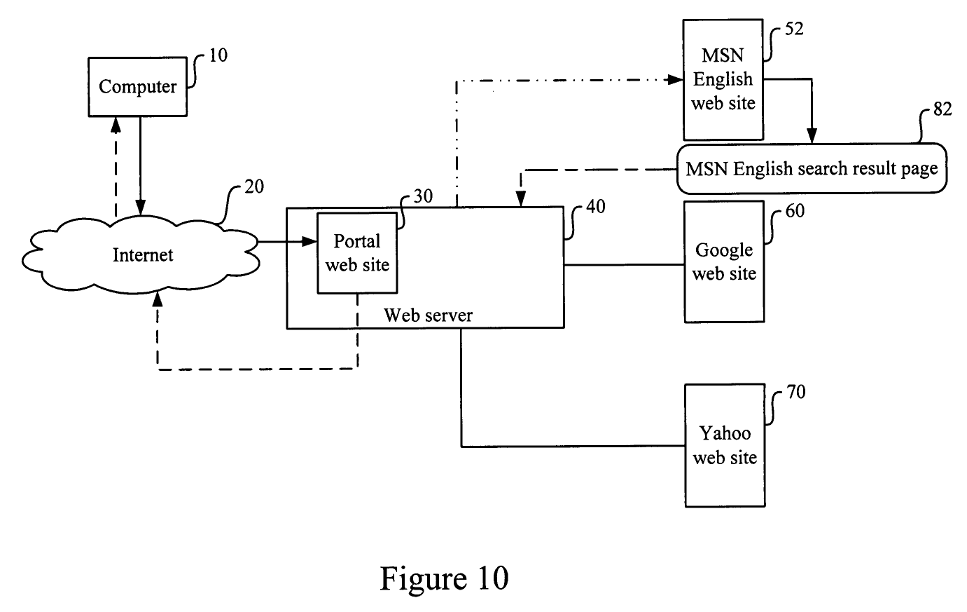

Refer to the FIG. 10, which is the flow-chart of the Internet search method described in FIG. 9. As shown in the Figure, a user using a web browser of a computer 10 enters a search keyword to a portal web site 30. The web server 40 translates the keyword according the language used in the network allocation. The solid lines shown in the Figure are paths that the un-translated keyword is sent; border lines are paths that the translated keyword is sent; center lines are paths that the un-translated result pages flow; and Dashed lines are paths that translated result pages flow.

A Japanese user who is not familiar with Chinese or English asks a Taiwanese user uses a computer 10 to connect a portal site 30 via the Internet 20. The portal site 30 is deployed on a web server 40 which connects to multiple search engines, including MSN English site 52, Google site 60 and Yahoo site 70. The Taiwanese user uses a computer 10 and enters a Chinese keyword into the portal site 30. Then, he selects MSN English site 52, chooses the language that result pages to be shown in and clicks a button, which enable the search.

When the search starts, the web server 40 translates the Chinese keyword into English, and sends the English keyword to the MSN English site 52. The MSN English site 52 generates English search result pages 82. The search result pages are translated into Japanese by the web server 40 and can be viewed by the Japanese user.

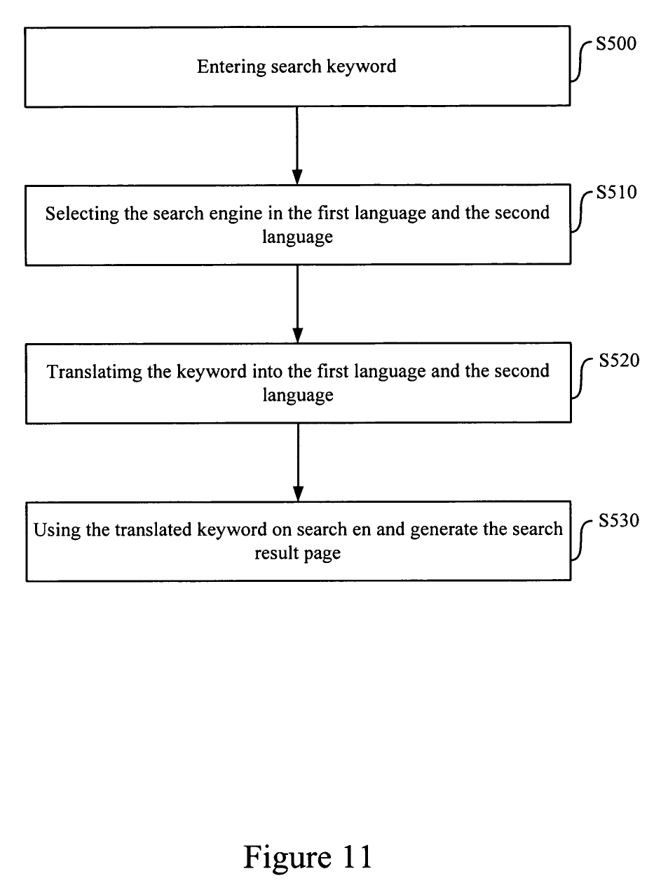

Refer to FIG. 11, which is a block diagram of a better example. The differences between FIG. 3 and FIG. 11 are that the first search keyword is translated into the second search keyword in FIG. 3. However, the web server translates the keyword according to the language used in the search engine in FIG. 11. This invention includes the step S500, a user enters a search keyword into the text area of a portal web site. In the step S510, the user selects a search engine, which uses the first and the second languages.

In step S520, when the search starts, the web server translates the search keyword to the first language and to the second language used in the search engine. In step S530, the search engine searches the keyword and generates the search result pages, which are in the first language and the second language.

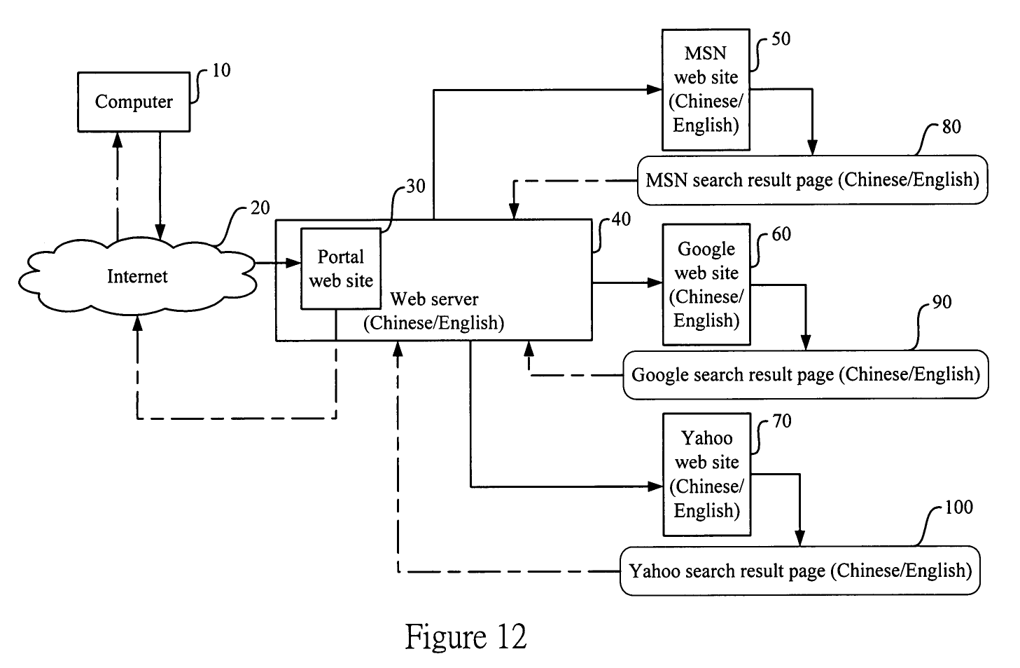

Refer to the FIG. 12, which is the flow-chart of the Internet search method described in FIG. 11. As shown in the Figure, a user using a web browser of a computer 10 enters a Chinese search keyword to a portal web site 30. Due to the search engine uses both Chinese and English, the web server 40 translates the Chinese keyword to English. The solid lines shown in the Figure are paths that the un-translated keyword is sent; border lines are paths that the translated keyword is sent; center lines are paths that the un-translated result pages flow. A Taiwanese user uses a computer 10 to connect a portal site 30 via the Internet 20. The portal site 30 is deployed on a web server 40, which connects to multiple search engines, including MSN site 50, Google site 60 and Yahoo site 70. The languages used in the MSN site 50, the Google site 60, and the Yahoo site 70 are both Chinese and English.

The Taiwanese user enters a keyword in Chinese into the portal site 30 from computer 10. He then selects multiple search engines and clicks a button, which enables the search. When the search starts, the web server 40 translates the Chinese keyword into English, and sends both Chinese and the English keyword to multiple search engines. The results generated are the MSN search result page 80, the Google search result page 90 and the Yahoo search result page 100. All the result pages are in both Chinese and in English. The Taiwanese user thus gets multiple result pages from portal site 30 and sees them shown on the computer 10.

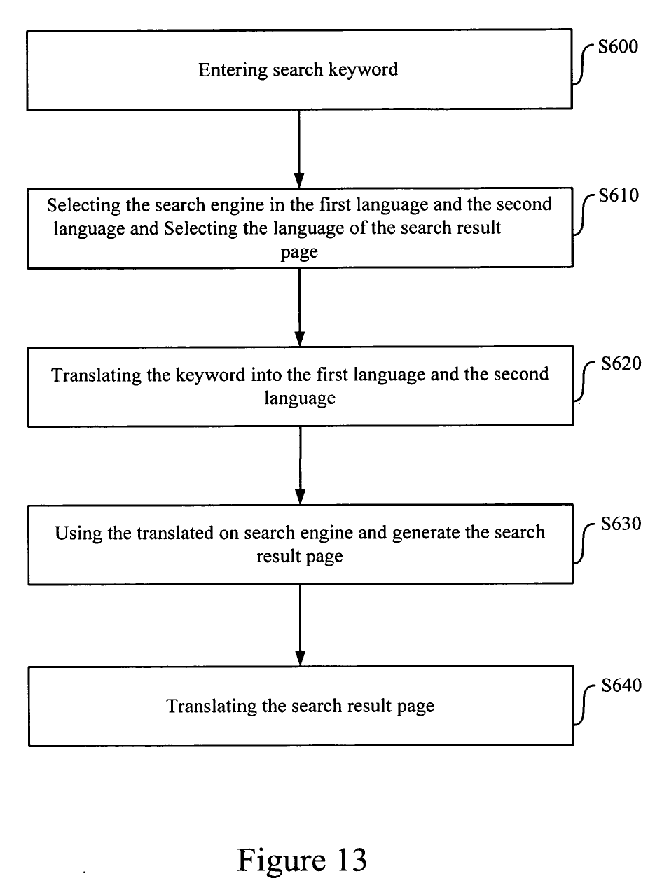

Refer to FIG. 13, which is a block diagram of a better example. The difference between FIG. 11 and FIG. 13 is that the language in search result page is the same as the first language or the second language used in the search engine in FIG. 11. However, the language in the search result page is not the same as the first language nor the second language used in the search engine in FIG. 13, that is the search result page is in the third language. This invention includes the process to translate search result page. In step S610, a user selects a search engine and the desired language in search result page. In step S620, when the search starts, the web server translates the search keyword to the first language and to the second language.

In step S630, the search engine searches the keyword and generates the search result pages. As shown in step S640, the web server translates the search result page to a language, which is different from the first language and the second language. Thus users using any browser in any language can view the search result page.

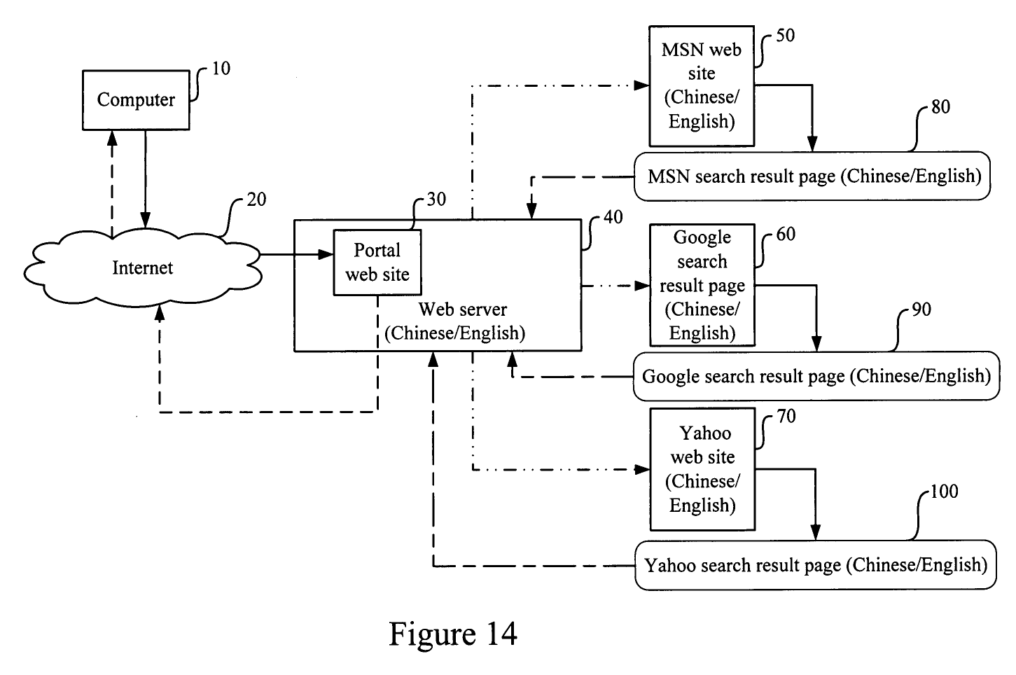

Refer to the FIG. 14, which is the flow-chart of the Internet search method described in FIG. 13. As shown in the Figure, a user using a web browser of a computer 10 enters a Chinese search keyword to a portal web site 30. The web server 40 translates the Chinese keyword to English. The search engine uses both Chinese and English in its databases. The solid lines shown in the Figure are paths that the un-translated keyword is sent; border lines are paths that the translated keyword is sent; center lines are paths that the un-translated result pages flow; and Dashed lines are paths that translated result pages flow.

A Korean is not familiar with Chinese. He asks a Taiwanese for help. The Taiwanese uses a computer 10 to connect a portal site 30 via the Internet 20. The portal site 30 is deployed on a web server 40, which connects to multiple search engines, including MSN site 50, Google site 60 and Yahoo site 70. The languages used in the MSN site 50, the Google site 60, and the Yahoo site 70 are both Chinese and English. The Taiwanese user enters a keyword in Chinese into the portal site 30 from computer 10, selects multiple search engines and select the language of the search result page is Korean. He then clicks a button, which enables the search.

When the search starts, the web server 40 translates the Chinese keyword into English, and sends both Chinese and the English keyword to multiple search engines. The results generated are the MSN search result page 80, the Google search result page 90 and the Yahoo search result page 100. All the result pages are in both Chinese and in English. The result pages are translated into Korean by the web server 40 and can be viewed by the Korean user.

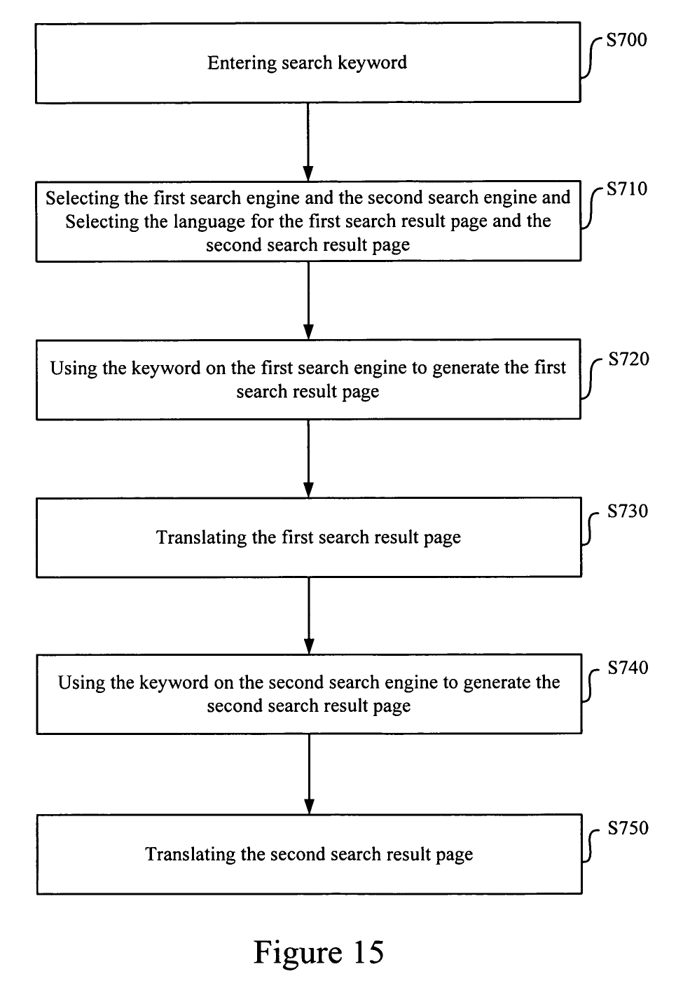

Refer to FIG. 15, which is a block diagram of a better example. The difference between FIG. 3 and FIG. 15 is that the first search keyword and the second search keyword are used in the first and the second search engines in FIG. 3. However, a single search keyword is used in both the first and the second search engine, which are in different language from search keyword in FIG. 15. This invention includes the steps step S700, a user enters a search keyword into the text area of a portal web site. The search keyword is composed of a single word or multiple words. In step S710, the user selects the first and the second search engines and then selects the language for the first and the second search result pages. In step S720, when the search starts, the web server uses the search keyword on the first search engine and generates the first search result page.

In step S730, the web server translates the first search result page to other language, which is different from that of the search keyword. In step S740, the web server uses the second keyword on the search engine and generates the second search result page. In step S750, the web server translates the second search result page to other language, which is different from that of the search keyword. In this manner, the first and the second search result pages are translated by the web server and can be viewed by users using other languages. The language used in search keyword may be the same as or different from that used on the search engine.

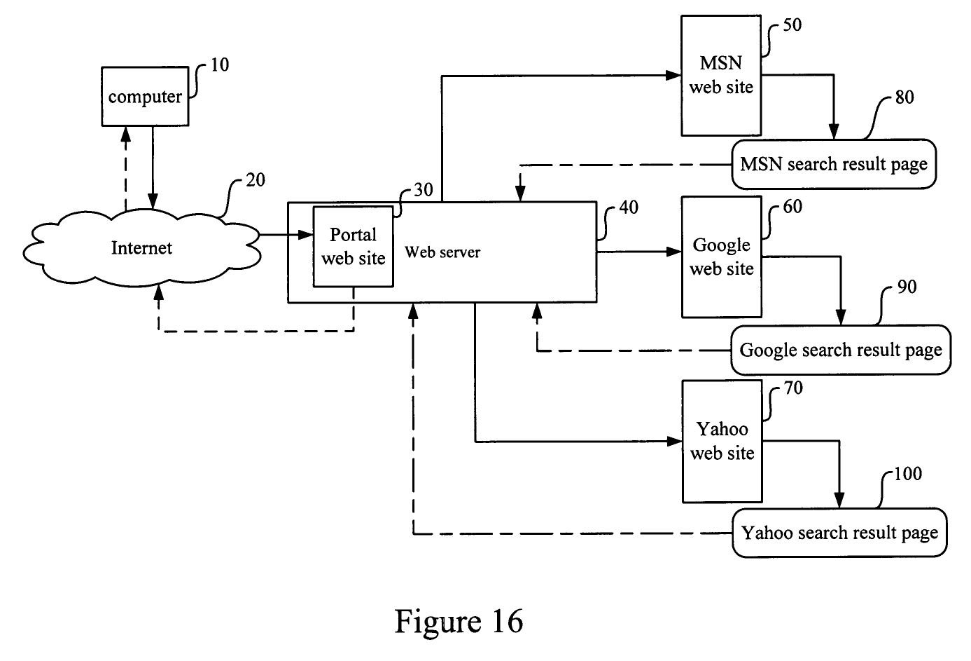

Refer to the FIG. 16, which is the flow-chart of the Internet search method described in FIG. 15. As shown in the Figure, a user using a web browser of a computer 10 enters a search keyword to a portal web site 30. The web server 40 passes the keyword to multiple search engines. The solid lines shown in the Figure are paths that the keyword is sent; center lines are paths that the result pages flows. A Taiwanese user, who is not familiar with English, asks an American user for help. The American user uses a computer 10 to connect a portal site 30 via the Internet 20. The portal site 30 is deployed on a web server 40, which connects to multiple search engines, including MSN site 50, Google site 60 and Yahoo site 70.

The American user enters an English keyword into the portal site 30 from computer 10. He then selects multiple search engines, chooses the language for search result pages is Chinese, and clicks a button, which enables the search. When the search starts, the web server 40 sends keyword to multiple search engines. The results generated are the MSN search result page 80, the Google search result page 90 and the Yahoo search result page 100. The result pages are then translated into Chinese by the web server 40 and can be viewed by the Taiwanese user.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A search method using HTTP protocol on the Internet including the steps of:
enter at least a first search keyword,
select a first search engine and a second search engine,
translate the search keyword into at least a second search keyword,
use the first and the second search keyword on the first search engine and generates a first search result web page, and
use the first and the second search keyword on the second search engine and generate the second search result web page.

2. The method as recited in claim 1 wherein the first search keyword is composed by a single word or multiple words.

3. The method as recited in claim 1 wherein a language used in the first search engine is the same as that of the first search keyword or the second search keyword.

4. The method as recited in claim 1 wherein a language used in the second search engine is the same as that of the first search keyword or the second search keyword.

5. The method as recited in claim 1 wherein the first search engine uses multiple languages.

6. The method as recited in claim 1, wherein the second search engine uses multiple languages.

7. The method as recited in claim 1, wherein the language used in the first search keyword may be the same as that used in the second search keyword.

8. The method as recited in claim 1, wherein the language used in the first search keyword may not be the same as that used in the second search keyword.

9. The method as recited in claim 1, wherein the first search result page can be translated into the language same as used in the first search keyword.

10. The method as recited in claim 1, wherein the second search result page can be translated into the language same as used in the second search keyword.

11. The method as recited in claim 1, wherein the first search result page can be translated into the language different from used in the first search keyword.

12. The method as recited in claim 1, wherein the second search result page can be translated into the language different from used in the second search keyword.

13. A search method using HTTP protocol on the Internet including the steps of:
enter a first search keyword, which is in a first language,
select a network allocation of a second language,
translate the keyword in the first language into the second language, and use the keyword in the second language to do a search and generate a search result page.

14. The method as recited in claim 13, wherein a search result page can be translated into the language same as the first language used in keyword.

15. The method as recited in claim 13 where the search result page can be translated into the language same as the second language specified in network allocation.

16. The method as recited in claim 13 where the search result page can be translated into the third language.

17. The method as recited in claim 13 where the network allocation is a network device, software, a search engine, or a firmware.

18. A search method using HTTP protocol on the Internet including the steps of:
enter a search keyword,
select a search engine web site, which uses a first language and a second language,
translate the search keyword to the language which is the same as the first language and the second language, and
use the search keyword on the search engine and generate a search result page.

19. The method as recited in claim 18, where the search result page can be translated into the first language.

20. The method as recited in claim 18, where the search result page can be translated into the second language.

21. The method as recited in claim 18, where the search result page can be translated into the third language.

22. The method as recited in claim 18, where the search result page can be translated into the language same as the keyword.

23. A search method using HTTP protocol on the Internet including the steps of:
enter a search keyword,
select a first and a second search engine,
use the search keyword on the first search engine and generate a first result page,
translate a first search page into a language different from the search keyword,
use the search keyword on the second search engine and generate a second result page, and
translate the second search page into the language different from the search keyword.

24. The method as recited in claim 23, where the search keyword is composed by a single word or multiple words.

25. The method as recited in claim 23, where the language used in the search keyword is the same as that in the first and the second search engine.
